(19) United States
(12) Patent Application Publication
(10) Pub. No.: US 2008/0050966 A1
(43) Pub. Date: Feb. 28, 2008

(54) Connector

(75) Inventors: Osamu Hashiguchi, Tokyo (JP); Kanji Inoue, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Japan Aviation Electronics Industry, Limited, Tokyo (JP)

(21) Appl. No.: 11/893,741

(22) Filed: Aug. 16, 2007

(30) Foreign Application Priority Data
Aug. 23, 2006 (JP) 2006-226755

(51) Int. Cl. H01R 12/24

(52) U.S. Cl. 439/495

(57) ABSTRACT

A connector capable of facilitating the insertion of a connected object, and obtaining a sufficient contact force. Contacts are held by a housing including a receiving space into which is inserted FPC. An actuator is mounted in the housing in a manner pivotally movable between open position for inserting FPC into the space, and closed position for holding FPC therein. The contacts have respective seesaw-type beams having one ends thereof formed with portions for contact with FPC, and the other ends thereof formed with power point portions for receiving the turning force of the actuator. The actuator has pressing portions for pushing downward the power point portions when open, to thereby lift them to move the contact portions out of the space, and cam portions for pushing upward the same when closed, to thereby push them downward to cause the contact portions to enter the space.

### BACKGROUND OF THE INVENTION

1. Field of the Invention

This invention relates to a connector, and more particularly to a connector suitable for electrically connecting between an FPC (Flexible Printed Circuit) and a printed circuit board.

2. Prior Art

Conventionally, there has been proposed a connector comprising a plurality of contacts, a housing that holds the contacts, and an actuator that is rotatably mounted on the housing and elastically deforms the contacts to thereby bring the contacts into contact with an FPC (see Japanese Laid-Open Patent Publication (Kokai) No. 2004-221067).

The contacts each include a seesaw-type beam that has one end thereof formed with a contact portion for contact with the FPC, and the other end thereof formed with a power point portion on which the turning force of the actuator acts.

When the actuator is pivotally moved from an FPC-inserting position to an FPC-connecting position, the power point portions of the contacts are pushed upward by the actuator, and the contact portions of the contacts are pushed downward such that they enter a receiving space in the housing, to be urged against the FPC. As a result, it is possible to obtain a contact force required for bringing the contacts into contact with the FPC.

However, in some connectors configured as above, when the actuator is in the FPC-inserting position, part of the contact portions of the contacts stand in a track along which the FPC is inserted. This has been a factor which causes an increase in the force required for inserting the FPC into the receiving space of the housing.

### SUMMARY OF THE INVENTION

The present invention has been made in view of these circumstances, and an object thereof is to provide a connector which is capable of facilitating the insertion of a connected object, and obtaining a sufficient contact force.

To attain the above object, the present invention provides a connector comprising a housing that has a receiving space into which a connected object is inserted, a plurality of contacts that are held by the housing, and each include a seesaw-type beam having one end thereof formed with a contact portion for contact with the connected object, and the other end thereof formed with a power point portion, and an actuator mounted in the housing such that the actuator is pivotally movable between an open position for allowing insertion of the connected object into the receiving space and a closed position for holding the connected object in the receiving space, the actuator including urging portions for enabling a turning force of the actuator to act on the power point portions when the actuator is in the open position, to push downward the power point portions to thereby move the contact portions out of the receiving space, and cam portions for enabling the turning force of the actuator to act on the power point portions when the actuator is in the closed position, to push upward the power point portions to thereby move the contact portions into the receiving space.

With the arrangement of the connector according to the present invention, it is easy to insert the connected object into the receiving space, and after the connected object is inserted into the receiving space, a large contact force is generated between the contact portions of the contacts and the connected object.

Preferably, the housing includes seesaw-type locking sections each having one end thereof formed with a nail portion for engagement with the connected object, and the other end thereof formed with a locking power point portion on which the turning force of the actuator acts, and the actuator includes urging portions for the nail portions, for pushing downward the locking power point portions when the actuator is in the open position, to thereby move the nail portions away from the connected object, and cam portions for the nail portions, for pushing upward the locking power point portions when the actuator is in the closed position, to thereby move the nail portions toward the connected object.

With the arrangement of the preferred embodiment, it is possible to prevent the connected object from being easily removed from the connector.

The above and other objects, features and advantages of the present invention will become more apparent from the following detailed description taken in conjunction with the accompanying drawings.

### BRIEF DESCRIPTION OF THE DRAWINGS

FIG. 1A is a plan view of a connector according to a first embodiment of the present invention;

FIG. 1B is a front view of the connector;

FIG. 1C is a bottom view of the connector;

FIG. 1D is a side view of the connector;

FIG. 2 is a cross-sectional view taken on line II-II of FIG. 1A;

FIG. 3 is a cross-sectional view taken on line III-III of FIG. 1A;

FIG. 4 is a cross-sectional view taken on line IV-IV of FIG. 1A;

FIG. 5 is a side view of a first contact of the FIG. 1 connector;

FIG. 6 is a side view of a second contact of the FIG. 1 connector;

FIG. 7 is a plan view of an actuator of the FIG. 1 connector;

FIG. 8 is a front view of the actuator;

FIG. 9 is a bottom view of the actuator;

FIG. 10 is a cross-sectional view taken on line X-X of FIG. 7;

FIG. 11 is a cross-sectional view taken on line XI-XI of FIG. 7;

FIG. 12 is a cross-sectional view taken on line XII-XII of FIG. 7;

FIG. 13A is a cross-sectional view of the connector in a state in which the actuator is closed with no FPC inserted into the connector;

FIG. 13B is a cross-sectional view of the connector in a state in which the actuator is being moved from the FIG. 13A state to an open state;

FIG. 13C is a cross-sectional view of the connector in a state in which contact portions of contacts are lifted by the actuator;

FIG. 14 is a plan view of a connector according to a second embodiment of the present invention;

FIG. 15 is a plan view of one end of the FIG. 14 connector;

FIG. 16A is a plan view of the FIG. 14 connector in a state in which no FPC has been inserted therein yet;

FIG. 16B is a cross-sectional view of the connector in the same state as shown in FIG. 16A;

FIG. 17 is a cross-sectional view of the connector in a state in which an FPC is inserted therein, and an actuator is open; and

FIG. 18 is a cross-sectional view of the connector in a state in which the actuator is closed.

### DETAILED DESCRIPTION OF THE PREFERRED EMBODIMENT

The present invention will now be described in detail with reference to the drawings showing preferred embodiments thereof.

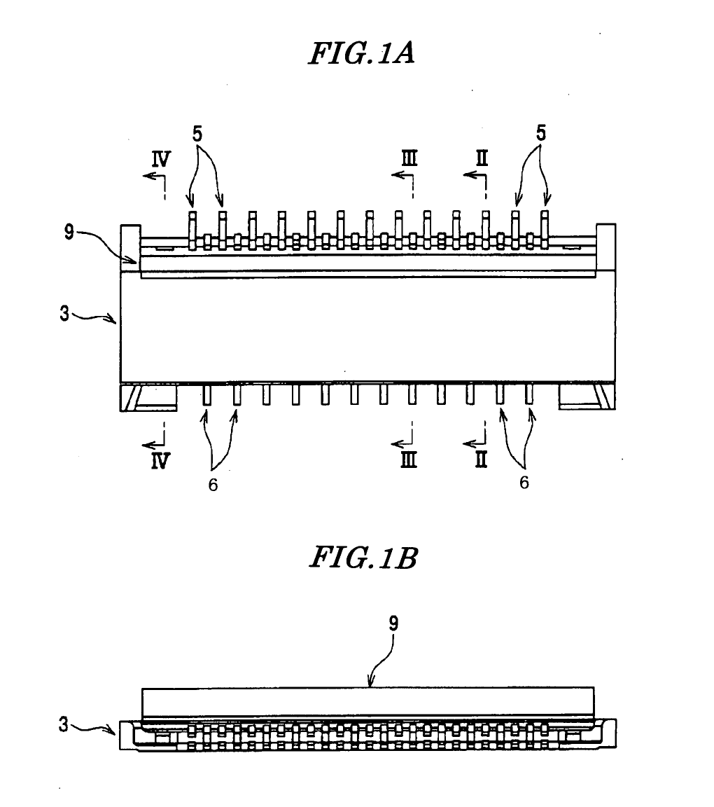

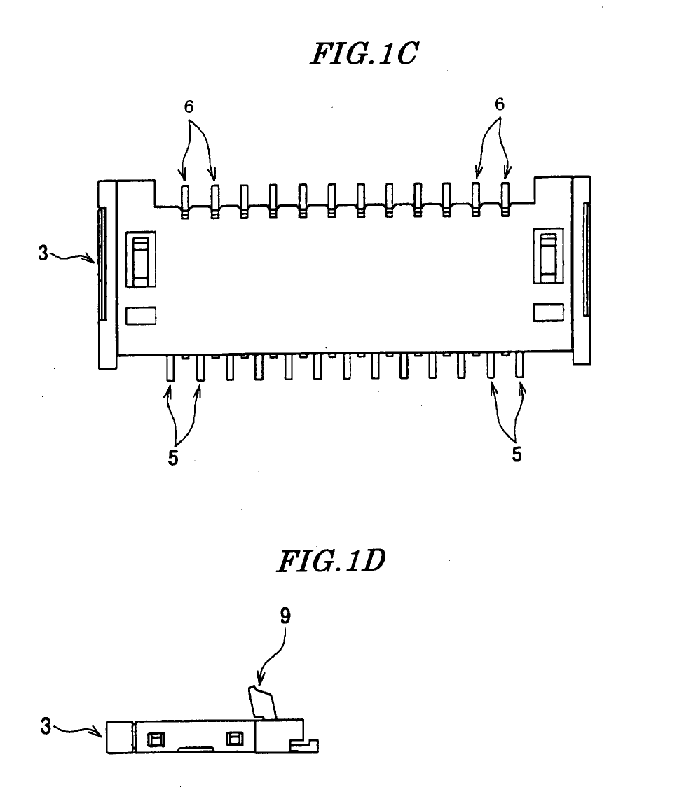

Referring to FIGS. 1 to 4, the connector is for an FPC (connected object), and is comprised of a housing 3, the first contacts 5, the second contacts 6, and the actuator 9.

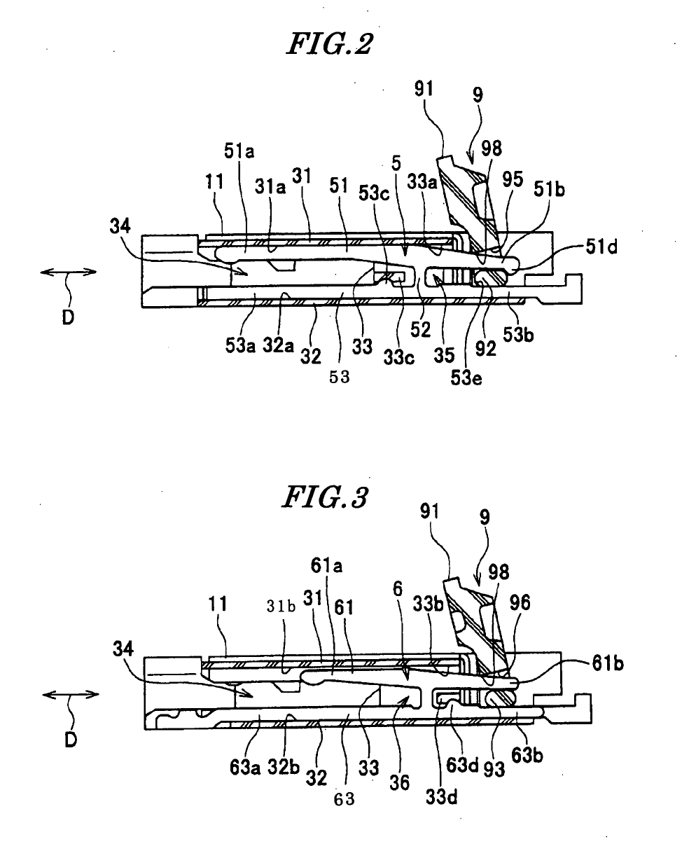

As shown in FIGS. 2 and 3, the housing 3 includes a ceiling 31, a bottom 32, and a connecting portion 33. Formed between the ceiling 31 and the bottom 32 is an FPC-receiving space (receiving space) 34.

The ceiling 31 has accommodation grooves 31a and accommodation grooves 31b formed in a lower surface thereof such that they are arranged alternately in the longitudinal direction of the housing 3. An upper surface of the ceiling 31 is covered with a shield plate 11.

The bottom 32 has accommodation grooves 32a and accommodation grooves 32b formed in an upper surface thereof such that they are arranged alternately in the longitudinal direction of the housing 3.

The connecting portion 33 connects the ceiling 31 and the bottom 32. The connecting portion 33 has accommodation holes 33a and accommodation holes 33b formed therein such that they are arranged alternately in the longitudinal direction of the housing 3. Each accommodation hole 33a extends along the direction of insertion of the FPC, not shown, and communicates with associated ones of the accommodation grooves 31a and 32a. Each accommodation hole 33b extends along the direction of insertion of the FPC, and communicates with associated ones of the accommodation grooves 31band 32b. The accommodation hole 33a has a press contact piece 33c formed therein. The accommodation hole 33b has a press contact piece 33d formed therein.

The above-described accommodation grooves 31a and 32a and accommodation holes 33a form a first contact-accommodating space 35. The above-described accommodation grooves 31b and 32b and accommodation holes 33b form a second contact-accommodating space 36.

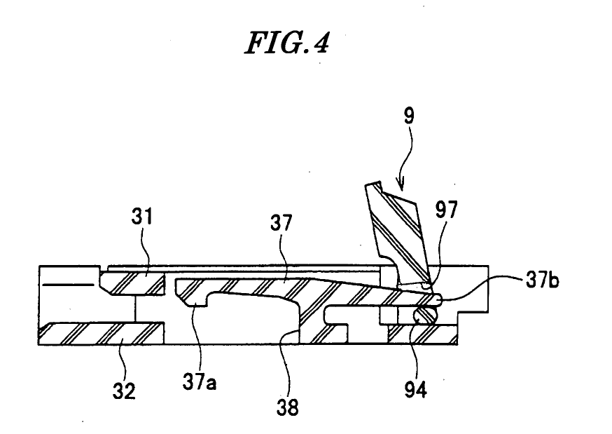

As shown in FIG. 4, the ceiling 31 has opposite ends in the longitudinal direction thereof formed with seesaw-type lances (locking sections) 37. Each lance 37 has one end thereof formed with a nail portion 37a. The other end of the lance 37 is formed with a locking power point portion 37b for engagement with a third cam portion (cam portion for the nail portion) 94 of the actuator 9, referred to hereinafter. The lance 37 is fixed to the bottom 32 via a spring piece 38 such that it can perform a seesaw operation.

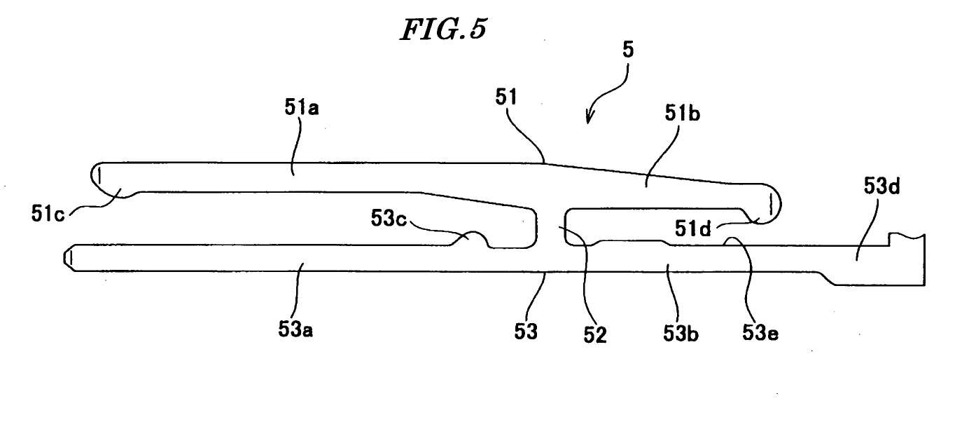

Referring to FIG. 5, each first contact 5 includes a first beam 51, a spring piece 52, and a second beam 53. The first beam 51 is connected to the second beam 53 via the spring piece 52 such that it can perform a seesaw operation. The first beam 51 and the second beam 53 are substantially parallel to each other. The first beam 51 has a portion toward one end thereof (portion on the left side of the spring piece 52 as viewed in FIG. 5) formed as a contact portion 51a, and a portion toward the other end thereof (portion on the right side of the spring piece 52 as viewed in FIG. 5) formed as a power point portion 51b. The contact portion 51a is formed with a contact point 51c. The power point portion 51b has a rear end thereof formed with an engaging portion 51d.

The second beam 53 has a portion toward one end thereof (portion on the left side of the spring piece 52 as viewed in FIG. 5) formed as a first beam portion 53a, and a portion toward the other end thereof (portion on the right side of the spring piece 52 as viewed in FIG. 5) formed as a second beam portion 53b. The first beam portion 53a is formed with a press-fitted piece 53c. The press-fitted piece 53c is press-fitted into the press contact piece 33c, whereby the first contact 5 is held in a state fixed within the first contact-accommodating space 35. The second beam portion 53b is formed with a terminal portion 53d. The terminal portion 53d is soldered to a printed wiring board, not shown. Further, the second beam portion 53b is formed with a recess 53e.

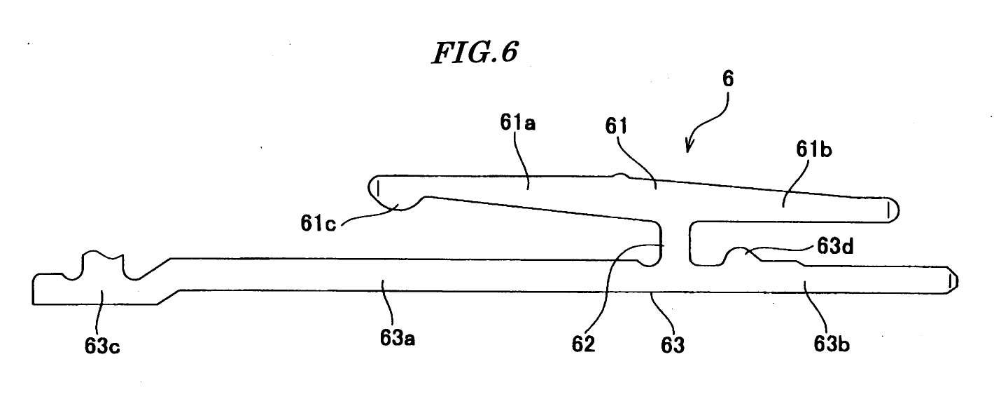

As shown in FIG. 6, each second contact 6 includes a first beam 61, a spring piece 62, and a second beam 63. The first beam 61 is connected to the second beam 63 via the spring piece 62 such that it can perform a seesaw operation. The first beam 61 is slightly inclined with respect to the second beam 63. The first beam 61 has a portion toward one end thereof (portion on the left side of the spring piece 62 as viewed in FIG. 6) formed as a contact portion 61a, and a portion toward the other end thereof (portion on the right side of the spring piece 62 as viewed in FIG. 6) formed as a power point portion 61b. The contact portion 61a is formed with a contact point 61c.

The second beam 63 has a portion toward one end thereof (portion on the left side of the spring piece 62 as viewed in FIG. 6) formed as a first beam portion 63a, and a portion toward the other end thereof (portion on the right side of the spring piece 62 as viewed in FIG. 6) formed as a second beam portion 63b. The first beam portion 63a has a foremost end thereof formed with a terminal portion 63c. The terminal portion 63c is soldered to the printed wiring board, not shown. The second beam portion 63b is formed with a press-fitted piece 63d. The press-fitted piece 63d is press-fitted into the press contact piece 33d, whereby the second contact 6 is held in a state fixed within the second contact-accommodating space 36.

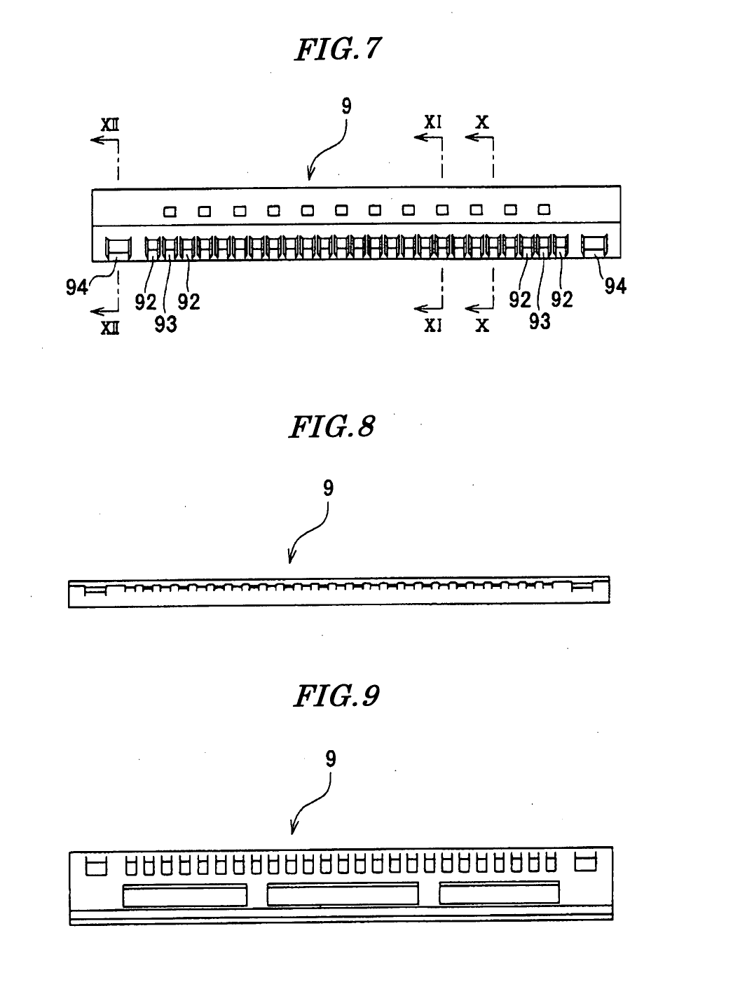

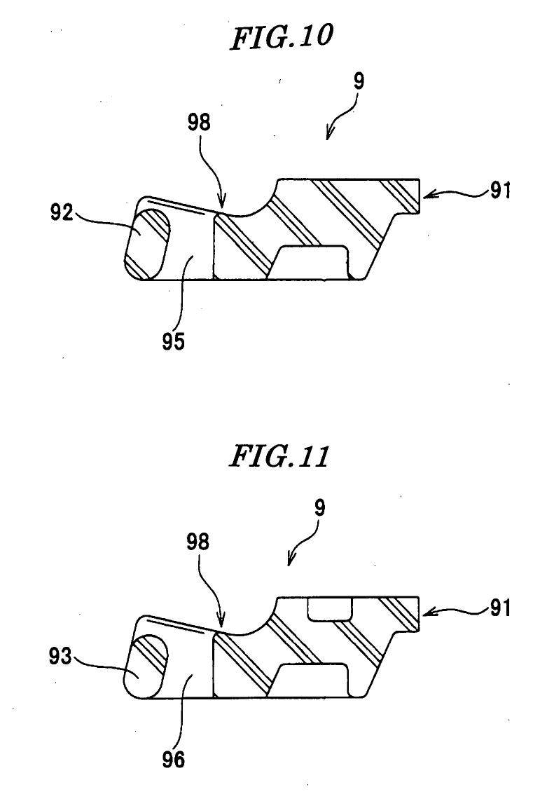

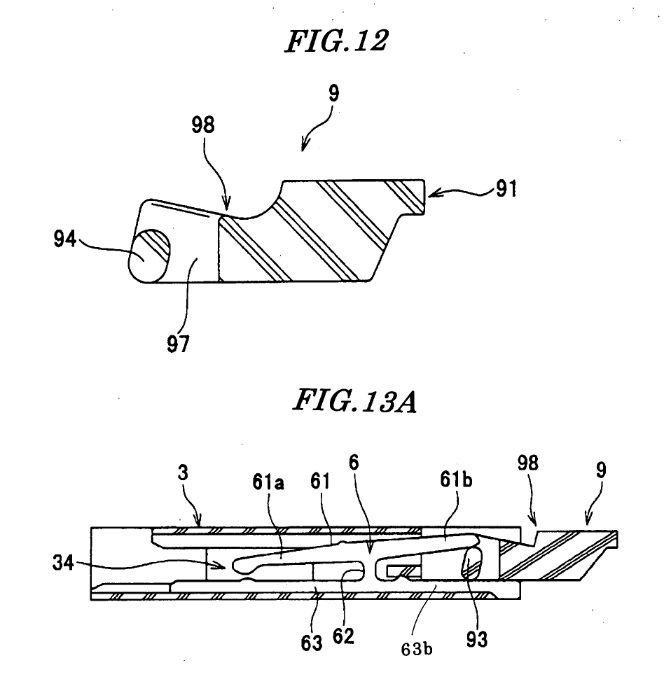

As shown in FIGS. 7 to 12, the actuator 9 has one end in the direction of the width thereof formed with an operating section 91, and the other end in the direction of the width thereof formed with first cam portions 92, second cam portions 93, and third cam portions 94. The first cam portions 92, the second cam portions 93, and the third cam portions 94 each have a substantially elliptical shape in cross section. Although in the present embodiment, the sizes thereof are different from each other, they may have the same size.

The operating section 91 has a substantially convex shape. The actuator 9 is operated by putting a finger on the operating section 91.

The first cam portions 92 and the second cam portions 93 are in an alternate arrangement.

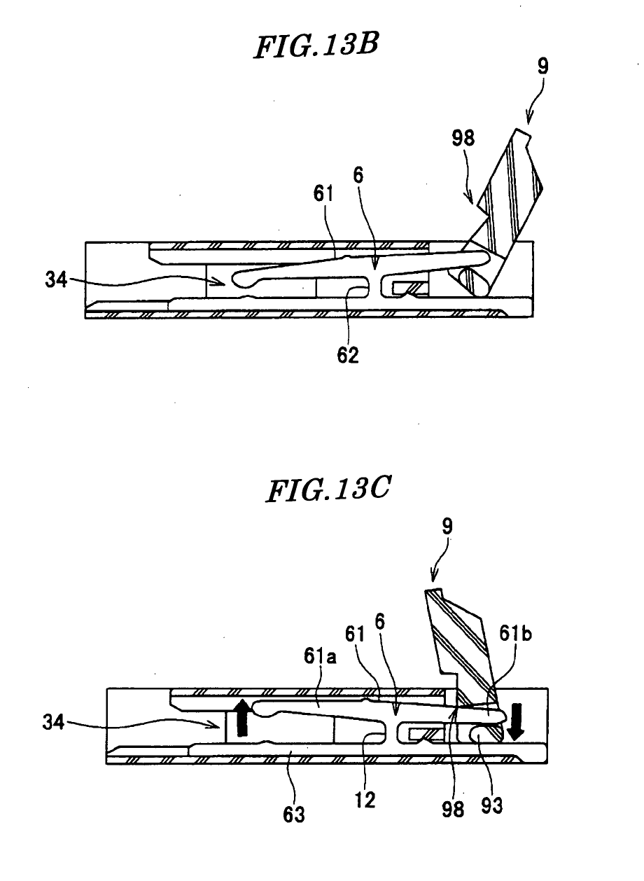

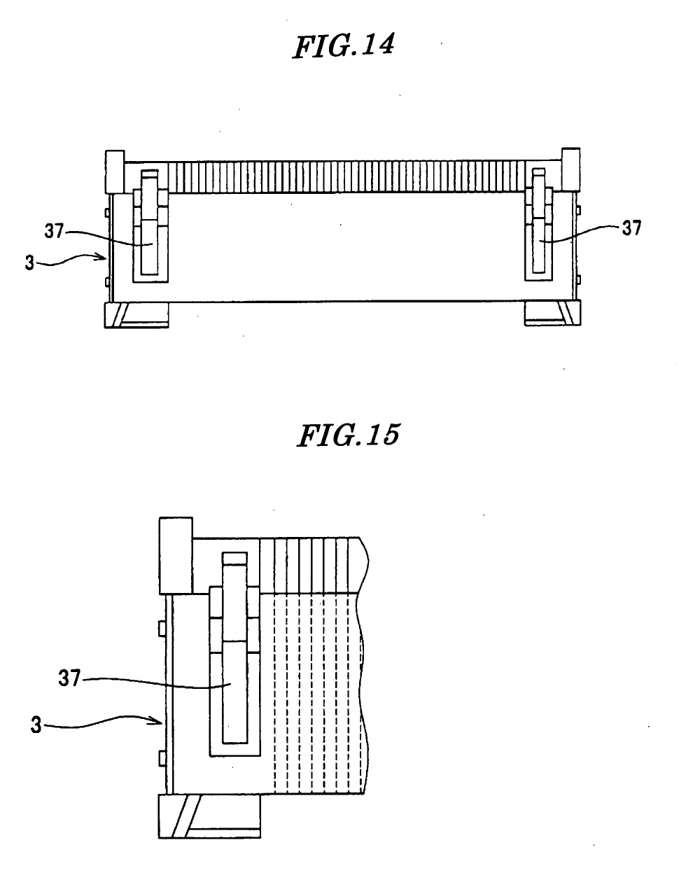

Each first cam portion 92 is sandwiched by the power point portion 51b and the second beam portion 53b of an associated one of the first contacts 5, and is further engaged with the engaging portion 51d and the recess 53e such that the first cam portion 92 is prevented from dropping off the associated first contact 5. Each second cam portion 93 is sandwiched by the power point portion 61b and the second beam portion 63b of an associated one of the second contacts 6. Therefore, the actuator 9 is pivotally held by the first contacts 5 such that it can be pivotally moved between an open position (position of the actuator 9 in a state where it can receive the FPC: the state shown in FIGS. 2 and 3) and a closed position (position of the actuator 9 in a state where the first and second contacts are brought into contact with the FPC: a state shown in FIG. 13A). Further, the first and second cam portions 92 and 93 each having a substantially elliptical shape in cross section are configured such that they are sandwiched by the power point portion 51b and the second beam portion 53b of the associated one of the first contacts 5, and the power point portion 61b and the second beam portion 63b of the associated one of the second contacts 6, respectively, and hence when the actuator 9 is in a position close to the open position, a moment for pivotally moving the actuator 9 toward the open position is generated, whereas when the actuator 9 is in a position close to the closed position, a moment for pivotally moving the actuator 9 toward the closed position is generated.

When the actuator 9 is in the closed position, the first cam portion 92 pushes upward the power point portion 51b of the associated first contact 5, whereby the contact portion 51a of the associated first contact 5 is pushed downward such that the contact portion 51a enters the FPC-receiving space 34.

The actuator 9 has through holes 95 formed therethrough at respective locations adjacent to the first cam portions 92. Each through hole 95 has an associated one of the power point portions 51b inserted therethrough.

When the actuator 9 is in the closed position, the second cam portion 93 pushes upward the power point portion 61b of the associated second contact 6, whereby the contact portion 61a of the associated second contact 6 is pushed downward such that the contact portion 61a enters the FPC-receiving space 34.

The actuator 9 has through holes 96 formed therethrough at respective locations adjacent to the second cam portions 93. Each through hole 96 has an associated one of the power point portions 61b extended therethrough.

The third cam portions 94 are formed at opposite ends of the actuator 9 in the longitudinal direction thereof. When the actuator 9 is in the closed position, each third cam portion 94 pushes upward an associated one of the locking power point portions 37b such that the nail portion 37a is inserted into a cutout formed in the FPC, not shown. The actuator 9 is formed with through holes 97 at respective locations adjacent to the third cam portions 94.

Edges of the through holes 95 and 96, toward the operating section 91, form pressing portions 98.

When the actuator 9 is in the open position (the state shown in FIGS. 2 and 3), the pressing portions 98 push downward the power point portions 51b and 61b inserted into the respective through holes 95 and 96, whereby the contact portions 51a and 61a of the respective first and second contacts 5 and 6 are lifted such that they are moved out of the FPC-receiving space 34.

Referring to FIG. 13A, when the actuator 9 is pivotally moved to the closed position without the FPC inserted into the connector, the first beam 61 of the second contact 6 is set such that it performs the seesaw operation through a larger pivot angle than that of the first beam 51 of the first contact 5, so that there is a fear that the spring piece 62 undergoes plastic deformation. Assuming that the spring piece 62 has been plastically deformed as shown in FIG. 13B, even if the actuator 9 is pivotally moved toward the open position, the first beam 61 remains in the FPC-receiving space 34. In the prior art, the FPC cannot be inserted when the connector is in this state.

In the present embodiment, however, as shown in FIG. 13C, it is possible to urge the power point portions 61b by the pressing portions 98 of the actuator 9. This makes it possible to move the contact portions 61a away from the FPC-receiving space 34.

At this time, the power point portions 51b of the first contacts 5 are also pressed by the pressing portions 98, and therefore the contact portions 51a of the first contacts 5 are also moved away from the FPC-receiving space 34 simultaneously.

As described hereinabove, according to the present embodiment, it is possible to facilitate the insertion of the FPC and obtain a sufficient contact force.

Component parts identical to those of the connector according to the first embodiment are designated by identical reference numerals, and detailed description thereof is omitted, while only main component parts different in construction from those of the first embodiment will be described hereinafter.

Although in the first embodiment, operating section-side edges of the through holes 97 of the actuator 9 are configured such that they do not press the lances 37, in the second embodiment, pressing portions 298 of the actuator 209 for pressing the nail portions press the locking power point portions 37b of the lances 37. The pressing portions 298 perform the same operation as that pressing portions 98 of the actuator 9.

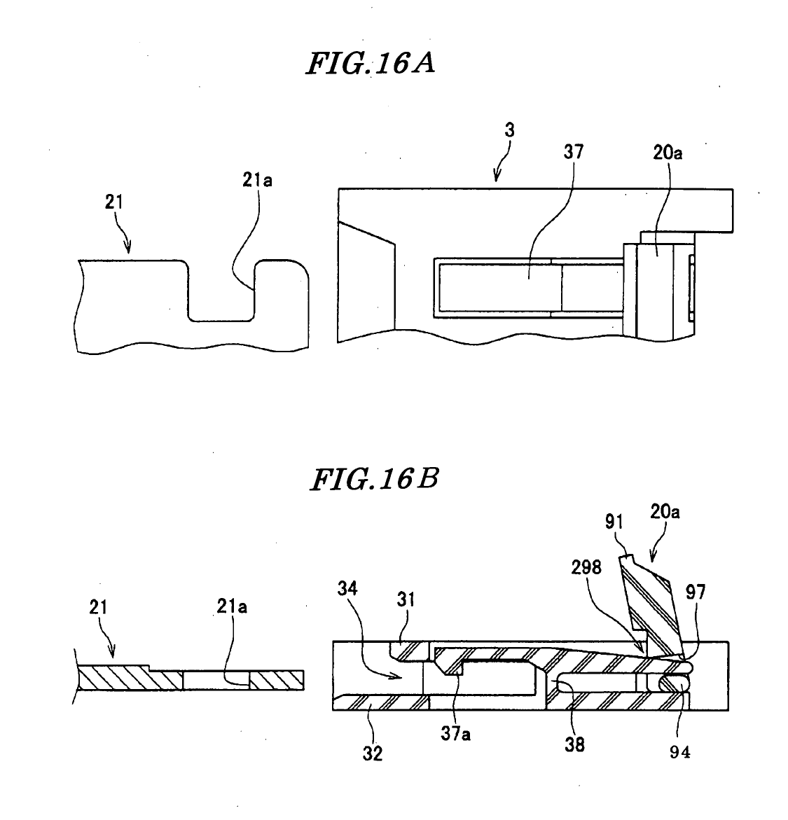

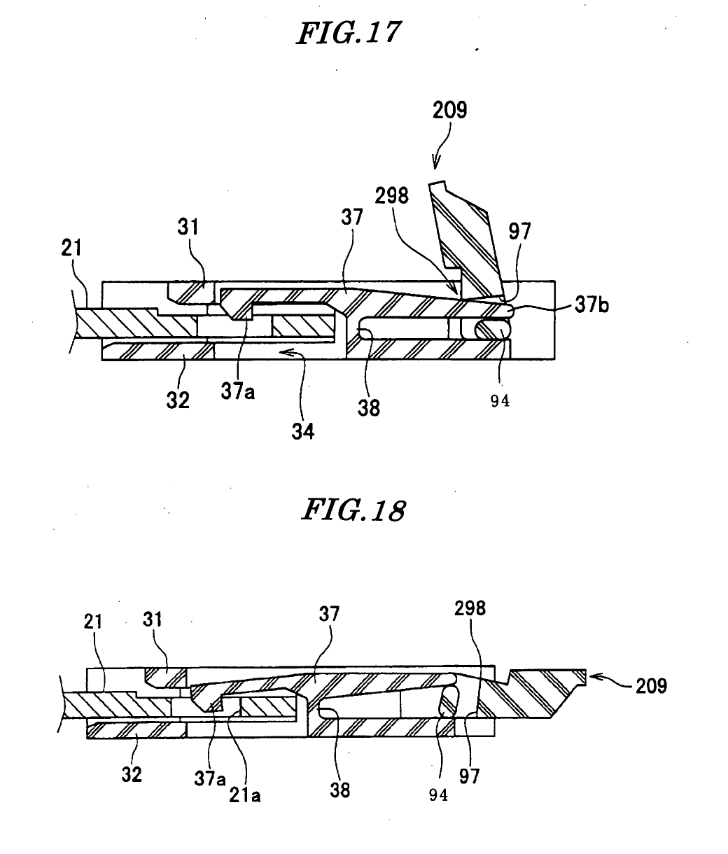

Referring to FIGS. 16A and 16B, the nail portion 37a of each lance 37 is configured to be slightly inserted into the FPC-receiving space 34 when the actuator 209 is in the open position. This causes the FPC 21 to be brought into slight contact with the nail portion 37a, when the FPC 21 is inserted into the FPC-receiving space 34, as shown in FIG. 17.

With this construction, the insertion of the FPC 21 is hardly hindered by the nail portion 37a, and further it is possible to prevent the FPC 21 from being displaced when the actuator 209 is pivotally moved from the open position to the closed position. If the actuator 209 is pushed until it reaches the closed position, the nail portion 37a can be positively inserted into a cutout 21a formed in the FPC 21, thereby making it possible to positively lock the FPC 21.

According to the present embodiment, it is possible to obtain the same advantageous effects as provided by the first embodiment, to prevent the FPC 21 from being easily removed from the connector.

It should be note that although in the above-described embodiments, the present invention is applied to the connector for an FPC, this is not limitative, but the present invention can also be applied to a connector e.g. for an FFC (Flexible Flat Cable).

It is further understood by those skilled in the art that the foregoing are the preferred embodiments of the present invention, and that various changes and modification may be made thereto without departing from the spirit and scope thereof.

What is claimed is:

1. A connector comprising:
a housing that has a receiving space into which a connected object is inserted;
a plurality of contacts that are held by said housing, and each include a seesaw-type beam having one end thereof formed with a contact portion for contact with the connected object, and the other end thereof formed with a power point portion; and
an actuator mounted in said housing such that said actuator is pivotally movable between an open position for allowing insertion of the connected object into the receiving space and a closed position for holding the connected object in the receiving space, said actuator including pressing portions for enabling a turning force of said actuator to act on the power point portions when the actuator is in the open position, to push downward the power point portions to thereby move the contact portions out of the receiving space, and cam portions for enabling the turning force of said actuator to act on the power point portions when the actuator is in the closed position, to push upward the power point portions to thereby move the contact portions into the receiving space.

2. A connector as claimed in claim 1, wherein said housing includes seesaw-type locking sections each having one end thereof formed with a nail portion for engagement with the connected object, and the other end thereof formed with a locking power point portion on which the turning force of said actuator acts, and
wherein said actuator includes pressing portions for the nail portions, for pushing downward the locking power point portions when the actuator is in the open position, to thereby move the nail portions away from the connected object, and cam portions for the nail portions, for pushing upward the locking power point portions when the actuator is in the closed position, to thereby move the nail portions toward the connected object.
